(19) United States
(12) Patent Application Publication
(10) Pub. No.: US 2007/0255442 A1
(43) Pub. Date: Nov. 1, 2007

(54) Process fault analyzer and method and storage medium

(75) Inventors: Toshikazu Nakamura, Kawasaki-shi (JP); Shigeru Obayashi, Mishima-shi (JP); Kenichiro Hagiwara, Yokohama-shi (JP); Yoshikazu Aikawa, Tokyo-to (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/717,781

(22) Filed: Mar. 14, 2007

(30) Foreign Application Priority Data
Mar. 15, 2006 (JP) P2006-070932

(51) Int. Cl. G06F 19/00

(52) U.S. Cl. 700/108

(57) ABSTRACT

The process fault analyzer includes a process data editing part for extracting a process characteristic quantity from process data in a time series stored in a process data storing part, a fault analysis rule data storing part for storing a fault analysis rule for performing fault detection on a product manufactured in a manufacturing system and on manufacturing equipment, based on the process characteristic quantity, and a fault determining part for determining existence/absence of a fault in a product and in manufacturing equipment based on the process characteristic quantity. A partial least square regression (PLS) model is used as an estimation model used for the fault analysis rule. Also, Q statistics and T² statistics are used, and the fault determining part determines a fault in manufacturing equipment when values of the statistics are the same as set value or more.

This application claims priority from Japanese patent application P2006-070932, filed on Mar. 15, 2006. The entire contents of the aforementioned application is incorporated herein by reference.

### BACKGROUND OF THE INVENTION

1. Field of the Invention

The present invention relates to a process fault analyzer, a method and a storage medium readable with a computer including a program for analyzing fault in a product to be processed and manufacturing equipment in association with a state of a process.

2. Description of the Related Art

The manufacturing process of products such as semiconductors and liquid crystal panels must be managed appropriately in order to improve a manufacturing yield of the product or to keep a good yield.

The semiconductor device is manufactured through a semiconductor process of 100 steps or more, and is manufactured by using a plurality of complicated pieces of semiconductor manufacturing equipment. Therefore, there are many processes of which a relation between a parameter showing a state of each manufacturing equipment (process equipment) and a characteristic of the semiconductor device manufactured by using each of the manufacturing equipment is not necessarily required. On the other hand, there is a demand that each step always be strictly managed in order to improve the yield of the manufactured semiconductor device.

In order to solve the above-described problem, in the invention disclosed in Japanese Patent Application Laid Open No. 2004-281461, diverse process data and process result data generated during processing are acquired, and from the process data thus acquired, a correlation model of the process data and its process result is obtained by a method of partial least squares. By using this model, the process result can be estimated during processing.

### SUMMARY OF THE INVENTION

In the invention disclosed in Japanese Patent Application Laid Open No. 2004-281461, it is assumed that process equipment is normally operated, and that collected process data accurately reflects a process state in process equipment. Therefore, for example, when a sensor, etc, mounted on process equipment is at fault, the process data to be used in prediction is not reliable, and therefore a correct prediction is impossible. Similarly, when equipment executing a process is at fault, a correct prediction is impossible, because the situation is different from the situation in which a model was prepared.

An object of the present invention is to provide a process fault analyzer, a method and a storage medium readable with a computer including a program capable of improving reliability of a determined result of existence/absence of fault in a product.

According to the present invention, a process fault analyzer detects fault in a process for each product based on process data obtained in a time series during executing the process, in a manufacturing system including one or a plurality of pieces of manufacturing equipment. The analyzer includes a process data storing part for storing the process data, a process data editing part for extracting a process characteristic quantity from the process data stored in the process data storing part, a fault analysis rule data storing part for storing a fault analysis rule for detecting fault in the product manufactured in a manufacturing system and in the manufacturing equipment, from the process characteristic quantity, and a fault determination part for determining an existence/absence of fault in the product and in the manufacturing equipment, based on the process characteristic quantity according to the fault analysis rule. A partial least square regression (PLS) model is used as an estimation model used for estimating a process processing result for the each product used for the fault analysis rule, and Q statistics and/or T² statistics are used, to determine that the manufacturing equipment is at fault when values of the statistics are the same as set values or more.

It is preferable that the Q statistics and/or T² statistics are calculated for the each product, and that a part is provided for notifying the fault in the manufacturing equipment when values of the Q statistics and/or the T² statistics are determined to show the fault successively for a previously designated number of times.

In addition, when the manufacturing equipment is determined to be normal based on values of the Q statistics and/or T² statistics, the fault determining part can regard estimation on the product of the existence/absence of the fault as effective.

In this case, it is preferable that the fault determining part notifies the estimation of the fault on the product when an effective estimation on the product is determined to show fault successively for a previously designated number of times.

According to the present invention, a process fault analysis method in a process fault analyzer detects fault in a process for each product based on the process data obtained in a time series during executing the program, in a manufacturing system including one or a plurality of pieces of manufacturing equipment. The method includes the steps of acquiring the process data in a time series and storing it in a process data storing part, extracting a process characteristic quantity from the process data stored in the process data storing part, and determining, based on the extracted process characteristic quantity, existence/absence of fault in a product and in the manufacturing equipment. The partial least regression (PLS) model is used as an estimation model for estimating a process processing result for each product used for the fault analysis rule. Q statistics and/or T² statistics are used, and the fault determining step includes a processing of determining the fault in the manufacturing equipment when values of the statistics are the same as set value or more.

According to the present invention, a storage medium stores a program for the computer to function as a process data editing part for extracting a process characteristic quantity from process data in a time series stored in a process data storing part, and a fault determining part for determining, according to a fault analysis rule, based on the process characteristic quantity, existence/absence of fault in a product manufactured in a manufacturing system and in a manufacturing equipment constituting the manufacturing system, and determining the fault in the manufacturing equipment using a partial least regression (PLS) model as an estimation model for estimating a process processing result for each product used for the fault analysis rule and Q statistics and/or T2 statistics, when values of the statistics are the same as set value or more.

Here, the “product” to be manufactured by the manufacturing process includes a semiconductor and an FPD (a flat panel display: a display using a liquid crystal, PDP, EL, FED, etc). The “product” may be a normal counting unit such as one sheet of semiconductor wafer and one sheet of glass substrate, or may be a unit used for a group of products such as one lot of these products, or may be a unit counting a part of the product such as an area defined on a large-sized glass substrate. An output of fault notifying information includes processing such as outputting to a display, notifying via e-mail transmission, and storing in storage equipment. The “fault in a product” corresponds to a fault in a state at an estimated value in an embodiment, and the “fault in manufacturing equipment” corresponds to a fault in a state during process in the embodiment. The fault of the manufacturing equipment (process equipment) includes a case in which a fault occurs in process data obtained from the manufacturing equipment, such as a failure of the equipment for executing process of the equipment and the fault of a sensor incorporated in the equipment.

In the present invention, determination of a process fault based on Q statistics and T² statistics, estimation of a process result by a least square method, and determination of a fault based on the estimated value are simultaneously performed. Therefore, reliability of an estimated value and determination of fault using the estimated value is improved, and 100% real time fault detection is made possible, since determination of fault is made based on an estimated value.

In addition, when it is arranged to determine whether or not a fault occurs in succession, a single (accidental) fault can be eliminated.

According to the present invention, determination of existence/absence of a fault in manufacturing equipment and existence/absence of a fault in a product are simultaneously performed. Therefore, reliability of a determined result of existence/absence of a fault in a product can be improved. Particularly, when the determination of existence/absence of a fault in a product is performed based on a normal process data, reliability on the determined result can be further improved.

### BRIEF DESCRIPTION OF THE DRAWINGS

FIG. 1 shows a block diagram of an example of a manufacturing system including a process fault analyzer according to an embodiment of the present invention;

FIG. 2 shows a block diagram of an example of an internal structure of the process fault analyzer;

FIGS. 3A, 3B and 3C show diagrams of an example of a data structure of various data processed by the process fault analyzer;

FIG. 4 shows a diagram of an example of a data structure of rule data stored in a fault analysis rule data storing part;

FIG. 5 shows a flowchart explaining a function of a fault analysis rule editing part;

FIG. 6 shows a flowchart explaining a function of a fault determining part;

FIG. 7 shows a flowchart explaining a function of the fault determining part;

FIG. 8 shows a diagram showing an example of information displayed in a fault display;

FIG. 9 shows a diagram of an example of information displayed in the fault display;

FIG. 10 shows a diagram of an example of information displayed in the fault display;

FIG. 11 shows a diagram of an example of information displayed in the fault display; and

FIG. 12 shows a diagram of an example of information displayed in the fault display.

### DETAILED DESCRIPTION OF THE PREFERRED EMBODIMENTS

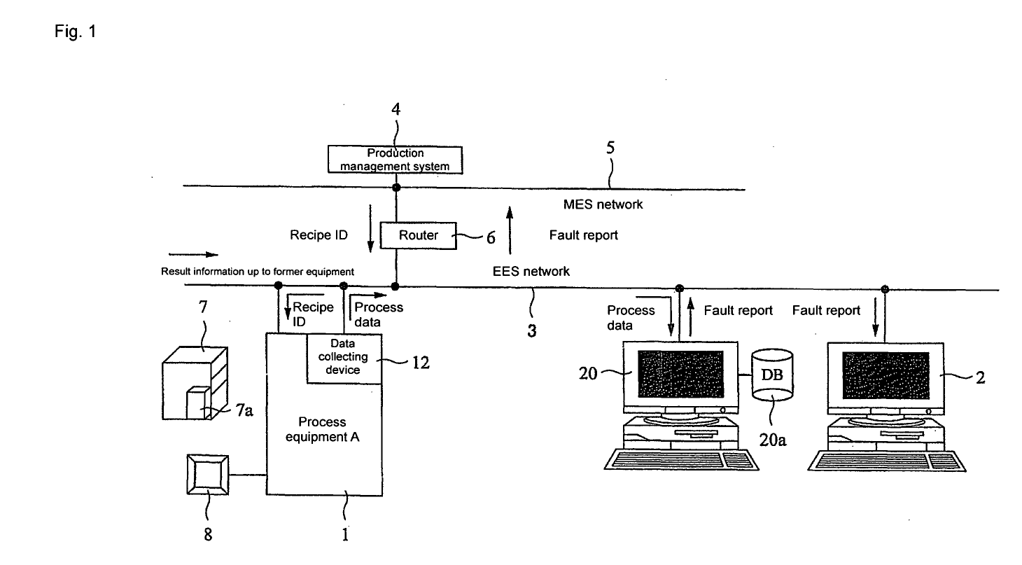

FIG. 1 shows a manufacturing system including a process fault analyzer according to an embodiment of the present invention. This manufacturing system includes process equipment 1, a process fault analyzer 20, and a fault display 2. These pieces of equipment are mutually connected via an EES (Equipment Engineering System) network 3, which is a network for exchanging more detailed process related information than production management information on high speed. Although not shown, other pieces of process equipment and inspection equipment used in a former stage of the process equipment 1 and in a later stage of the process equipment 1 are also connected to the EES network 3. This system further includes a production management system 4 including an MES (Manufacturing Execution System) and an MES network 5 connected to the production management system 4 for transmitting production management information. The EES network 3 and the MES network 5 are connected via a router 6. The production management system 4 that exists on the MES network 5 can access each pieces of equipment on the EES network 3 via the router 6.

In this production system, for example, semiconductors and liquid crystal panels are manufactured, and the process equipment 1 executes a process (such as a deposition process on a wafer) for manufacturing semiconductors, etc. In a semiconductor manufacturing process and a liquid crystal panel manufacturing system, a predetermined number of wafers and glass substrates (referred to as “wafer” hereinafter) to be processed are set in a cassette 7, moved per cassette, and subjected to a predetermined processing in the process equipment 1. When one product is manufactured, a predetermined processing is respectively performed in a plurality of pieces of process equipment 1. In this case, movement between the pieces of process equipment is performed per cassette. The predetermined number of wafers mounted on the cassette 7 makes the same lot.

In the semiconductor manufacturing system according to the present embodiment, a production ID is given for each wafer, since wafers require individual management. This product ID can be set by combining a lot ID and an identification number in the lot. Namely, if the lot ID is “0408251” and the number of wafers that can be set in the lot is one digit number, the product ID of the second glass substrate in the lot (the identification number is “2” in the lot) can be set as “04082512” by adding to the final digit the identification number in the lot.

Of course, instead of lot ID or together with lot ID, product IDs of all wafers enclosed may be recorded in a tag 7a, and the process equipment 1 (process data collecting equipment 12) may acquire all the product IDs stored in the tag 7a. When one wafer is to be set in the cassette 7, the ID recorded in the tag 7a can be used as a product ID as it is. Note that when analysis is performed by lot, acquisition of a product ID and preparation of a product ID based on a lot ID are not necessary.

An RF-ID (radio frequency identification) tag 7a is attached to the cassette 7. Electromagnetic connection is made between the tag 7a and an RF-ID read/write head 8 connected to the process equipment 1, and arbitrary data can be read/written in a non-contact manner. Therefore, the tag 7a is also referred to as a data carrier. The tag 7a stores a lot ID (a lot ID as a basis of the product ID or a product ID itself), and information such as an output time from equipment of the preceding stage.

The process equipment 1 acquires from the MES network 5 a recipe ID sent from the production management system 4 via the router 6. The process equipment 1 has a correspondence table between a recipe ID and a process to be actually performed, and executes a process according to the acquired recipe ID. The equipment ID for identifying each pieces of equipment is set in the process equipment 1.

The process equipment 1 incorporates therein a process data collecting device 12. The process data collecting device 12 is connected to the EES network 3. The process data collecting device 12 collects process data, which is information related to a state of the process equipment 1, in a time series, during a period of executing the process in the process equipment 1 or during a stand-by period. The process data includes a voltage and a current during operation of the process equipment 1, and waiting time from output of the process equipment 1 for executing a process until input to the process equipment 1 for executing a next process. In addition, when the process equipment 1 has a plasma chamber, and performs a deposition processing to a wafer, the process data also includes a pressure in the plasma chamber, a gas flow rate to be supplied with the plasma chamber, and a wafer temperature and a plasma light intensity, etc. The process equipment 1 has a detector for detecting the process data, and an output from the detector is given to the process data collecting device 12.

The process data collecting device 12 collects an output time from the equipment of the previous stage read from the tag 7a via the RF-ID read/write head 8 and an input time to the process equipment 1 in which the wafer is currently set. By obtaining a difference between the output time and the input time, the waiting time from the previous equipment can be calculated. In addition, the RF-ID read/write head 8 writes the output time, etc, in the tag 7a as needed, when the wafer is outputted from the process equipment 1.

The process data collecting device 12 has a communication function. The process data collecting device 12 collects every kind of process data generated in the process equipment 1, and outputs it to the EES network 3, with the product ID and the equipment ID associated with the collected process data. The kind of data to be collected is not limited to the aforementioned data, but may include further information.

The process fault analyzer 20 is a general personal computer in terms of hardware, and each function of the equipment is realized by an application program operated on an operating system such as Windows (registered trademark).

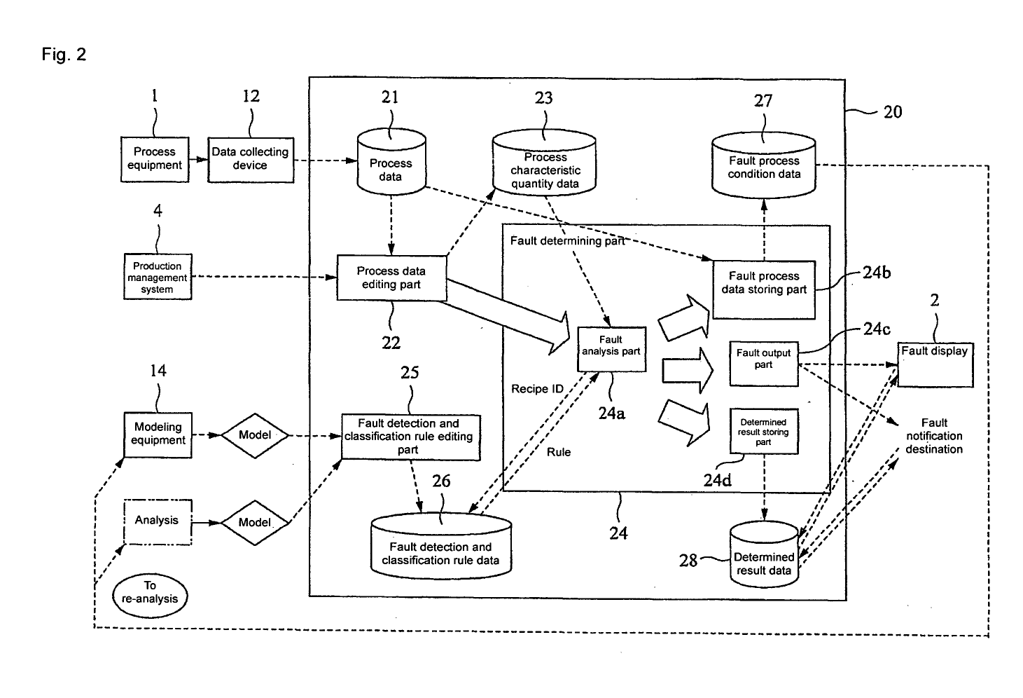

FIG. 2 shows an internal structure of the process fault analyzer 20. The process fault analyzer 20 includes a process data storing part 21 for storing the process data of the process equipment 1 sent from the process data collecting device 12, a process data editing part 22 for calculating the process characteristic quantity from each piece of process data stored in the process data storing part 21, a process characteristic quantity data storing part 23 for storing the process characteristic quantity calculated by the process data editing part 22, a fault determining part 24 for determining existence/absence of a fault based on the process characteristic quantity data stored in the process characteristic quantity data storing part 23, a fault process data storing part 27 for storing the process data for the wafer determined to be at fault by the fault determining part 24, a determined result data storing part 28 for storing determined result of the fault determining part 24, a fault detection and classification rule data storing part 26 for storing a fault detection and classification rule used for performing determination by the fault determining part 24, and a fault detection and classification rule editing part 25 for accessing the fault detection and classification rule data storing part 26 and adding and/or changing the fault detection and classification rule. Each storing part may be an external storage device (database 20a) or may be provided in an internal storage device of the process fault analyzer 20.

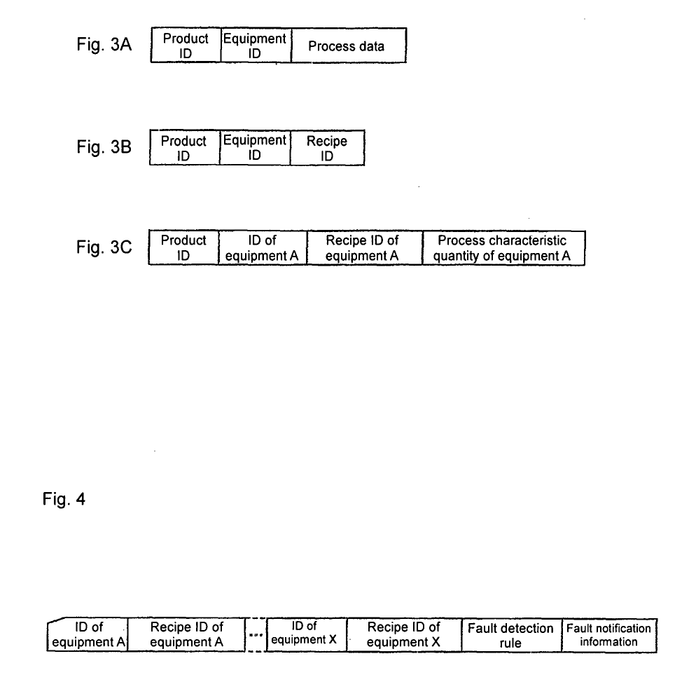

As shown in FIG. 3A, the process data stored in the process data storing part 21 is associated with the product ID and the equipment ID. In addition to the process data collected by the process data collecting device 12, the process data includes date/time information (date+time) as to when the process data was collected. The process data is stored in a time series in the process data storing part 21 for each pieces of the process equipment, per each product ID and in accordance with the date/time information. FIG. 1 shows an example wherein the process data of one piece of process equipment 1 is supplied with the process fault analyzer 20, and fault analysis is performed based on this process data. However, when the product passes through a plurality of pieces of process equipment, the process data obtained by the plurality of pieces of process equipment may be supplied with the process fault analyzer 20. In this case, the aforementioned data is prepared for the number of pieces of the equipment.

The process data storing part 21 is constituted of a temporary storing part such as a ring buffer, and deletes process data (overwrites new process data) at a predetermined timing after finishing a process.

The process data editing part 22 calls out process data stored in a time series in the process data storing part 21, and calculates the process characteristic quantity per sheet. The process characteristic quantity, for example, is not only calculated from the value of the process data such as a peak value, a sum, an average value for the same product ID, but also includes such data as time in which a value of process data exceeds a set threshold value.

The process data editing part 22 acquires a recipe ID outputted from the production management system 4 together with the product ID and the equipment ID. The recipe is a command and a setting, and a set of parameters previously determined for the process equipment. There are a plurality of recipes depending on an object to be processed or a step of processing, and a difference of the equipment, and they are managed by the production management system 4. A recipe ID is given to each recipe. A recipe for a wafer to be processed by the process equipment 1 is specified by the equipment ID, the product ID, and the recipe ID.

The process data editing part 22 acquires a set of the product ID, the equipment ID, and the recipe ID as shown in FIG. 3B by the following procedure. First, the process data editing part 22 accesses the production management system (MES) 4, and searches for a corresponding recipe ID, with the product ID of the wafer to be analyzed and the equipment ID specifying the process equipment 1 as keys. Subsequently, the process data editing part 22 acquires the searched recipe ID directly from the production management system 4 or via the process data collecting device 12. When a recipe ID is acquired via the process data collecting device 12, it may be obtained in such a way that the process data collecting device 12 acquires from the production management system (MES) 4 the recipe ID for the process under progressing, and transfers it to the process fault analyzer 20 together with the equipment ID and the process data of the process equipment 1.

The process data editing part 22 combines the calculated process characteristic quantity data and the acquired recipe ID, with the product ID and the equipment ID as keys, and stores the combined data in the process characteristic quantity data storing part 23 for the corresponding equipment ID. Therefore, a data structure of the process characteristic quantity data storing part 23 is as shown in FIG. 3C.

The fault detection and classification rule editing part 25 acquires a model obtained by analysis by modeling equipment 14 or an analysis by a person, defines the fault analysis rule, and stores it in a fault analysis rule data storing part 26. As the modeling equipment 14, modeling equipment, etc, using data mining as disclosed in Japanese Patent Application Laid-Open No. 2004-186445 can be used, for example. Here, the data mining is a method of extracting a rule and a pattern from a large-scale database, and as a specific method thereof, a method called decision tree analysis and a method called regression tree analysis are known.

Further, the fault analysis rule editing part 25 registers fault-notifying information corresponding to the fault analysis rule. Thus, as shown in FIG. 4, the data structure of the fault analysis rule data storing part 26 takes a table structure in which the equipment ID of each process equipment, the recipe ID of each process equipment, the fault analysis rule, and the fault-notifying information are associated one another.

The fault-notifying information includes the fault display 2 for displaying a determined result based on the fault analysis rule, information specifying an output destination such as a notification destination to which the determined result is notified, and the specific notification content. The notification destination is an e-mail address of a person in charge, for example. Both of the fault display 2 and the notification destination may be registered, or only one of them may be registered. When a plurality of output destinations are provided, for example, the fault-notifying information can be classified by a degree of fault and a place of fault obtained by the determination, and can be divided in accordance with the classification. A plurality of designations can be made to the fault display, notification destination, and notification content, for one classification. As the fault analysis rule, a multiple linear regression, a PLS linear regression, a decision tree analysis, Mahalanobis distance, a principal component analysis, a moving principal component analysis, a DISSIM, Q statistics, and T² statistics are combined and used.

This fault analysis rule is a rule for detecting existence/absence of a fault in a product from the process characteristic quantity, and existence/absence of a fault in process equipment itself. The fault analysis rule for estimating existence/absence of a fault in a product includes a fault determination formula whereby a fault is calculated and processed based on a process characteristic quantity, and a determination condition whereby whether or not a value (y) obtained by the fault determination formula shows a fault. In addition, by using a PLS (Partial Least Squares) method as fault detection, the fault classification can be performed. Fault factor data is obtained by the fault classification. The fault factor data includes process data or a name indicating a characteristic quantity and a contribution rate data.

The contribution rate data is the data indicating which process data and its characteristic quantity have an influence on a fault to what extent. The larger the numerical value of the contribution rate data is, the larger the degree of the influence on the fault is. Namely, there is a high possibility of causing the fault. Fault factor data is extracted, including the contribution rate data including the bits up to N-bits (such as 5 bits) at top level of the value of the contribution rate data calculated by the fault classification. Based on the extracted fault factor data, a worker understands which process data should be examined when dealing with the detected fault.

In this embodiment, the contribution rate for determining the fault factor data is obtained by a regression formula obtained by the PLS (Partial Least Squares) method. The regression formula obtained by this PLS method is shown as follows.
y=b0+b1*x1+b2*x2 +. . . +b(n−1)*×(n−1)+bn*xn

In the above formula, x1, x2, . . . xn are process characteristic quantities respectively, and b0, b1, b2, . . . bn are coefficients. b1, b2, . . . bn are weight values of each process characteristic quantity. When the value of y obtained by the above regression formula exceeds a threshold value, it is determined to be a fault.

The contribution rate of each process characteristic quantity by using the PLS method is obtained in the following way. First, when each of the variables (x1, x2, . . . xn) indicates an average value, the estimated value of the PLS is defined as Y. Then, how much contribution is made by each term to the size of y−Y, which is the difference between Y and y obtained by assigning the actually obtained process characteristic quantity to each variable. Namely, when the average value of each variable is defined as X1, X2, . . . Xn, the value of each term of the aforementioned formula is as follows.
b1(x1−X1), b2(x2−X2), . . . , bn(xn−Xn)

In this way, the value of each term, obtained by multiplying the difference between the average value and an actually measured value, with the coefficients, is defined as the contribution rate data of each process characteristic quantity. As a result of performing a factor classification, which process characteristic quantity is a problem can be specified.

Q characteristic quantity and T² statistics quantity are used for determining existence/absence of a fault in process equipment. Namely, by using a principal component analysis (PCA), a management limit (normal space) is set, which is then defined as a threshold value, with reference to the value obtained by using data for model construction (process characteristic quantity data +inspection data). Then, during operation (during detection of a fault), a real time (per sheet) determination as to whether or not a process state is normal is made from the aforementioned threshold value. Here, the Q characteristic quantity and the T² statistics are obtained by the following formula.

$$Q = {\sum }_{P = 1}^{P} {( {x}_{P} - {X}_{P} )}^{2}$$

$${T}^{2} = {\sum }_{r = 1}^{R} \frac{{t}_{r}^{2}}{{σ}_{{t}_{r}}^{2}}$$

Here, tr is an r-th principal component score in the principal component analysis, and R is the number of the principal components adopted.

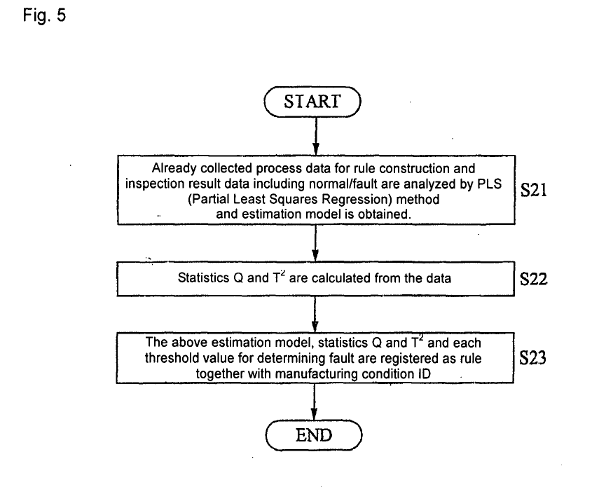

As a specific processing function of the fault analysis rule editing part 25 regarding the PLS, the flowchart as shown in FIG. 5 is executed. First, the process data for constructing a rule that has been already collected, and inspection result data including normal/fault data are analyzed by the PLS method, and an estimation model is obtained (S21). Subsequently, from this data, values of the statistics Q and T² are calculated (S22). Then, the aforementioned estimation model, the values of the statistics Q and T², and each threshold value for determining a fault are registered together with the recipe ID as a rule (S23). It should be noted that the processing steps S21 and S22 may be executed by the modeling equipment 14.

The fault determining part 24 includes a fault analyzing part 24a, a fault process data storing part 24b, a fault output part 24c, and a determined result storing part 24d. The fault analyzing part 24a performs determination of fault in accordance with the process characteristic quantity read from the process characteristic quantity data storing part 23 by using the fault detection and classification rule stored in the fault analysis rule data storing part 26.

Both existence/absence of a fault and fault classification are performed in the determination of fault executed by the fault analysis part 24a.

As described above, the determination of existence/absence of a fault in process equipment is performed by using Q characteristic quantity and T² statistics quantity, and when at least one of the Q characteristic quantity and the T² statistics quantity exceeds a threshold value, the process equipment is estimated to have a fault. However, even when the Q characteristic quantity and the T² statistics quantity exceed a threshold value, there is still a possibility that a value of a fault is in some cases shown from an external cause and other reason except process equipment. Therefore, in this embodiment, fault occurrence of process equipment is notified when Q characteristic quantity or T2 statistics quantity exceeds a threshold value successively N times.

When a fault is detected in the fault analysis part 24a, the fault process data storing part 24b reads from the process data storing part 21 the process data on the wafer determined to be at fault, and stores it in the fault process data storing part 27 as fault process data. At this time, the fault process data may be registered in association with a result of the fault determination (the value of y).

When a fault is detected in the fault analysis part 24a, the fault output part 24c outputs a fault message to a designated fault display. The outputted fault message is stored in the fault analysis rule data storing part 26. In addition, when fault classification is performed, detailed data such as a contribution rate is also outputted. Further, the fault output part 24c has a function of outputting a fault message by a method designated with respect to a designated fault notification destination when a fault is detected in the fault analysis part 24a. As an example, the fault output part 24c transmits an e-mail to a designated address. The outputted fault message is stored in the fault analysis rule data storing part 26. In addition, when fault classification is performed, detailed data such as contribution rate may also be outputted.

The determined result storing part 24d stores in the determined result data storing part 28 a result of determination of fault in the fault analysis part 24aas determined result data. Namely, the result of determination of fault is stored together with a PLS estimated value, an estimated value contribution rate, and the Q and T² statistics, and can be searched from the fault display, etc. Of this determined result data, all determined results may be stored or only the result determined to be at fault may be stored.

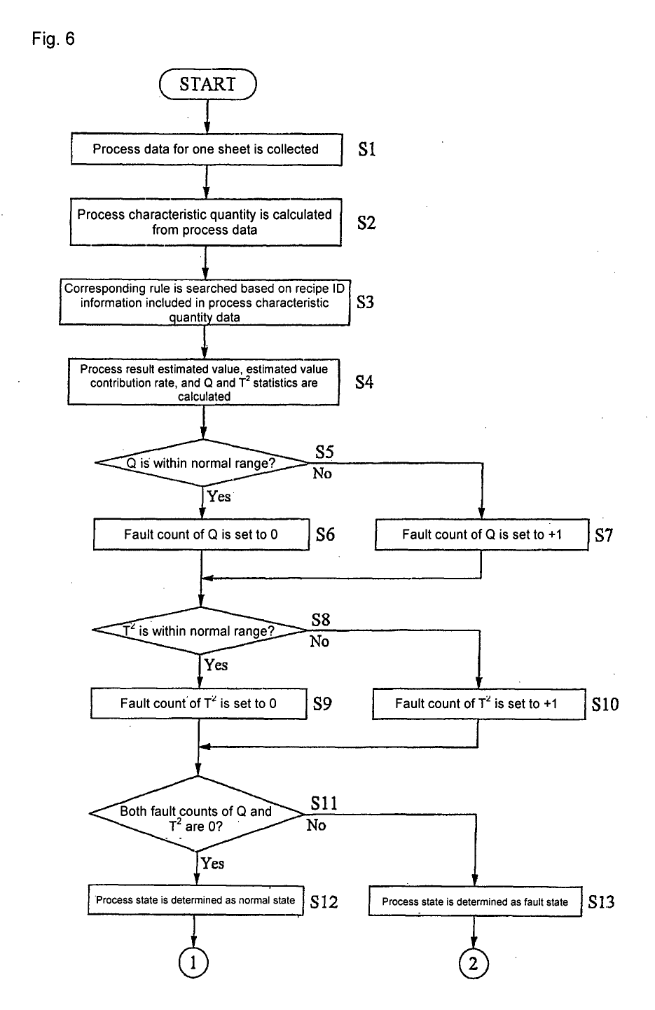

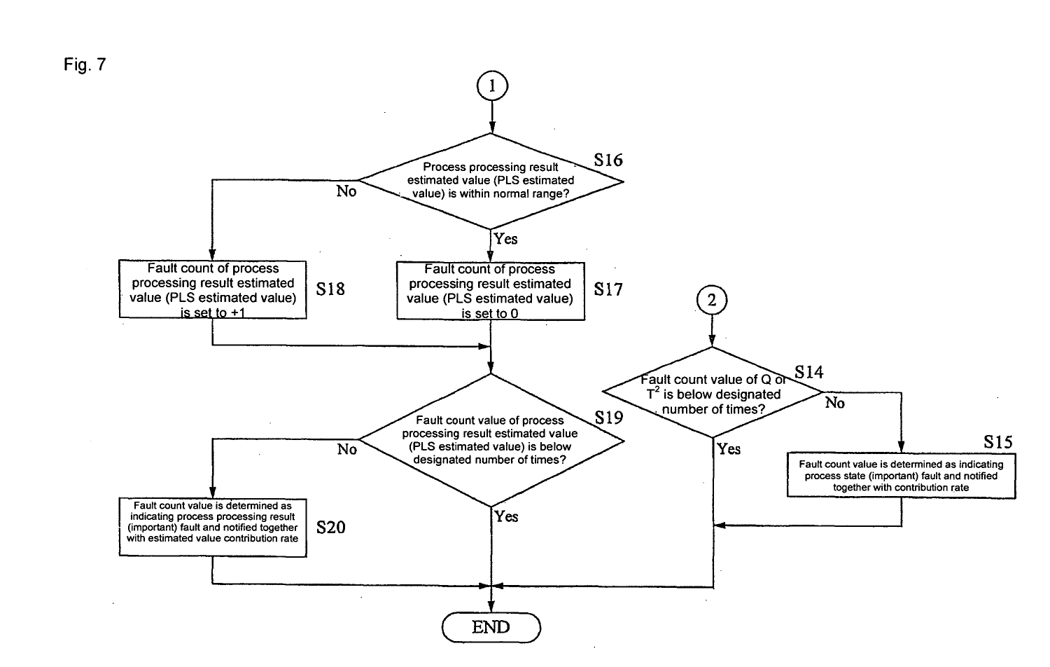

A specific processing function of the fault analysis part 24a is shown in the flowcharts of FIGS. 6 and 7. The process data editing part 22 collects process data of product for one sheet (S1), and calculates process characteristic quantity from this process data (S2). The process characteristic quantity thus calculated is stored in the process characteristic quantity data storing part 23.

The fault analysis part 24a accesses the process characteristic quantity data storing part 23, and extracts of process characteristic quantity data for one sheet, with one product ID as a key, and acquires its recipe ID. Then, the fault analysis part 24a accesses the fault detection and classification rule data storing part 26 and acquires fault detection and classification rule corresponding to the recipe ID (S3).

Based on the acquired process characteristic quantity and the fault detection and classification rule, the fault analysis part 24a calculates the process result estimated value (the value of y), the estimated value contribution rate, and the Q statistics and T² statistics (S4). The fault analysis part 24a determines whether or not Q is within a normal range (S5), and when it is in the normal range, resets a count value of a fault counter of Q to 0 (S6), and when it is out of the normal range, increments the count value of the fault counter of Q by one (S7). Similarly, the fault analysis part 24a determines whether or not T² is within a normal range (S8), and when it is within the normal range, resets a count value of a fault counter of T² to 0 (S9), and when it is out of the normal range, increments the count value of the fault counter of T² by one (S10).

The fault analysis part 24a determines whether or not count values of both of fault counters of Q and T² are 0 (S11), and when both of them are 0, determines a process state to be a normal state (S12), and when at least one of them is not 0, determines the process state to be a fault state (S13).

When a process state is normal, the fault analysis part 24a determines whether or not a process processing result estimated value (such as a PLS estimated value) is within a normal range (S15), and when it is within the normal range, resets a count value of a fault counter of the process processing result estimated value (such as a PLS estimated value) to 0 (S17), and when it is out of the normal range, increments the count value of the fault counter of the process processing result estimated value (such as a PLS estimated value) by one (S18).

After the aforementioned step S17 or S18 is executed, the fault analysis part 24a determines whether or not the count value of the fault counter of the process processing result estimated value (such as a PLS estimated value) is under designated number of times (S19), and when it is the same as the designated number of times or more, notifies the process result estimated value, the estimated contribution rate, and Q and T² statistics (S20).

Meanwhile, when the process state is at fault, the fault analysis part 24a determines whether or not the count value of the fault counter of Q or T² is below the designated number of times (S14), and when it is the same as the designated number of times or more, notifies it together with the contribution rate as a process state (important) fault (S15).

A fault is notified in accordance with fault notification information corresponding to a previously set determination condition. Specifically, the fault output part 24c outputs a message to a previously set fault display 2, and notifies by e-mail transmission to a previously set fault notification destination. Contents to be notified include occurrence date/time information and a fault notification ID in addition to fault display information stored in the fault analysis rule data storing part 26, and the recipe ID.

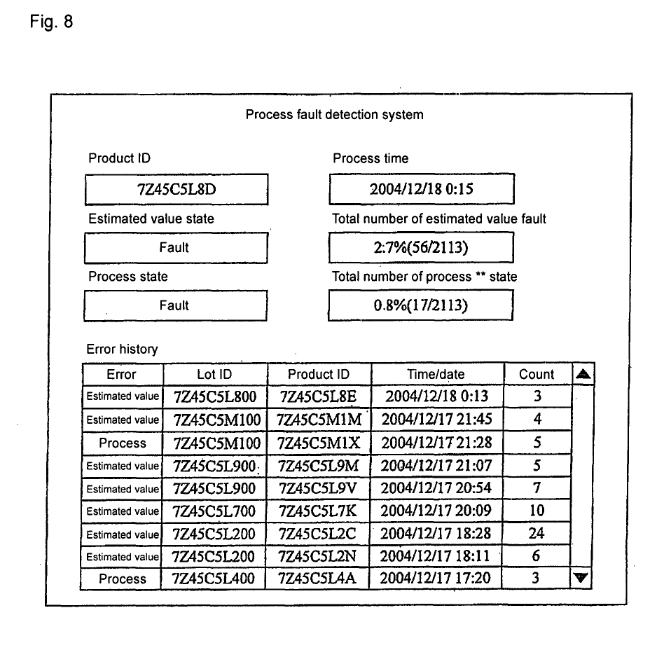

FIG. 8 shows a display example of the fault display 2 based on the fault notification. In the display screen in FIG. 8, when a fault notification of a product is received, the fault display 2 regards the message in a display area of the “estimated value state” as “fault”, and when the fault notification of the process equipment is received, regards the message in a display area of the ” process state” as “fault”. In addition, a history of the received fault notification is stored, and the history information is also displayed at the same time.

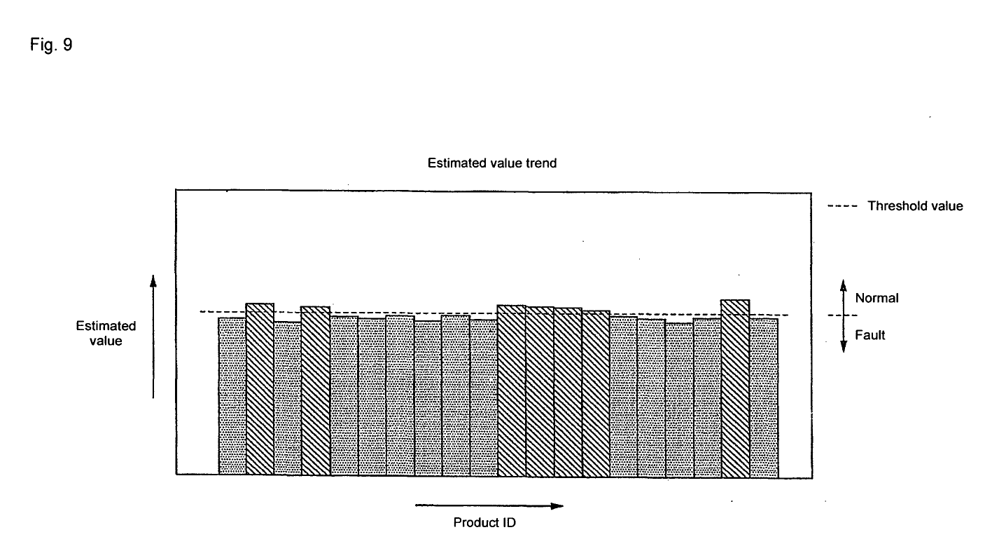

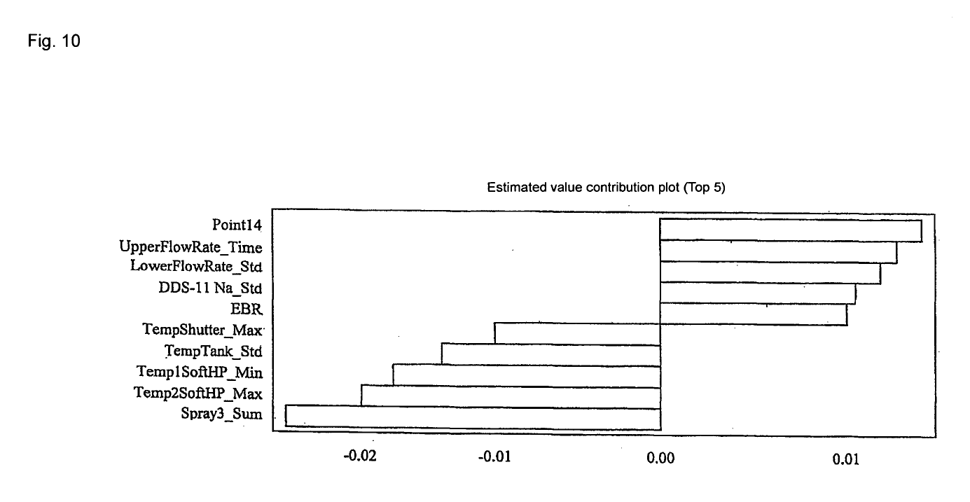

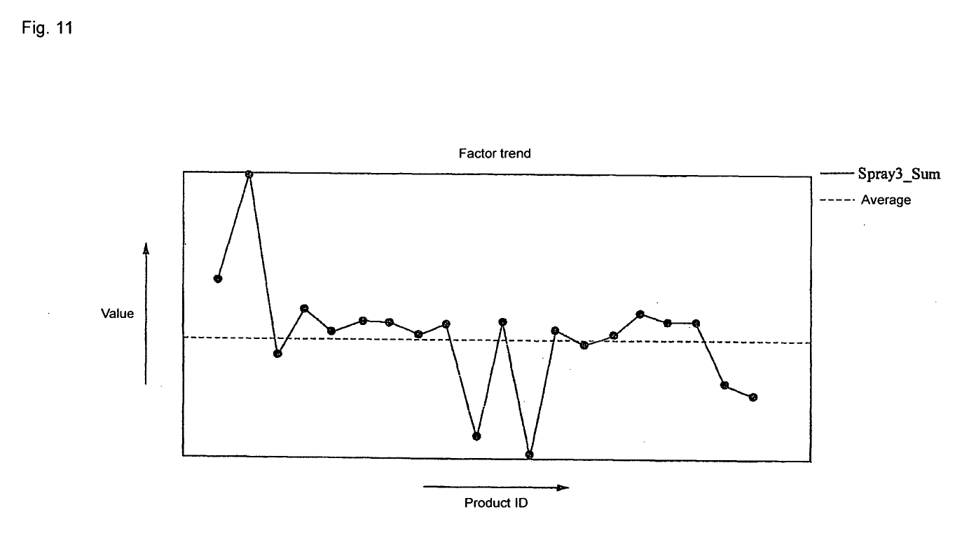

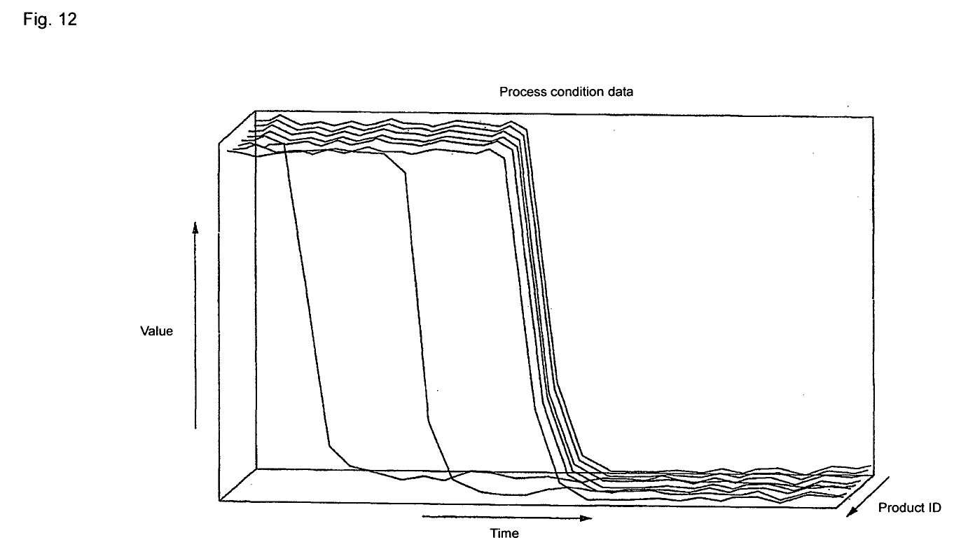

Further, a display format is not limited to a fault monitor showing a current state plus history information as shown in FIG. 8. The fault display 2 can take various formats, such as displaying an estimated value trend as shown in FIG. 9, displaying an estimated value high contribution rate factor as shown in FIG. 10, displaying a factor trend of high contribution rate as shown in FIG. 11, and displaying occurrence in time-series data of a high contribution rate factor as shown in FIG. 12.

What is claimed is:

1. A process fault analyzer for detecting fault in a process for each product based on process data obtained in a time series during executing the process, in a manufacturing system including one or a plurality of pieces of manufacturing equipment; the analyzer comprising:
a process data storing part for storing the process data;
a process data editing part for extracting a process characteristic quantity from the process data stored in the process data storing part;
a fault analysis rule data storing part for storing a fault analysis rule for detecting fault in the product manufactured in the manufacturing system and in the manufacturing equipment from the process characteristic quantity; and
a fault determining part for determining existence/absence of fault in the product and in the manufacturing equipment based on the process characteristic quantity according to the fault analysis rule;
wherein a partial least square regression model is used as an estimation model for estimating a process processing result for the each product used for the fault analysis rule, and Q statistics and/or T² statistics are used, and
when values of the statistics are the same as set values or more, the fault determining part determines that the manufacturing equipment is at fault.

2. A process fault analyzer according to claim 1, wherein
the Q statistics and/or T² statistics are calculated for the each product, and
the analyzer further comprises a part for notifying the fault in the manufacturing equipment when values of the Q statistics and/or the T² statistics are determined to show the fault successively for a previously designated number of times.

3. A process fault analyzer according to claim 1, wherein
when the manufacturing equipment is determined to be normal based on values of the Q statistics and/or T² statistics, the fault determining part regards estimation on the product as effective.

4. A process fault analyzer according to claim 3, wherein
when an effective estimation on the product is determined to show fault successively for a previously designated number of times, the fault determining part notifies the estimation of the fault on the product.

5. A process fault analyzing method in a process fault analyzer for detecting fault in a process for each product based on process data obtained in a time series during executing the process, in a manufacturing system including one or a plurality of pieces of manufacturing equipment, the method comprising the steps of:
acquiring and storing the process data in a process data storing part;
extracting a process characteristic quantity from the process data stored in the process data storing part; and
determining, based on the extracted process characteristic quantity, existence/absence of fault in a product manufactured in the manufacturing system and in the manufacturing equipment, wherein
a partial least square regression model is used as an estimation model for estimating a process processing result for each product used for the fault analysis rule, and Q statistics and/or T² statistics are used, and
the fault determining step includes a processing of determining the fault in the manufacturing equipment when values of the statistics are the same as set values or more.

6. A storage medium readable with a computer storing a program for the computer to function as:
a process data editing part for extracting a process characteristic quantity from process data in a time series stored in a process data storing part; and
a fault determining part for determining, according to a fault analysis rule, based on the process characteristic quantity, existence/absence of fault in a product manufactured in a manufacturing system and in manufacturing equipment constituting the manufacturing system, and determining the fault in the manufacturing equipment using a partial least square regression model as an estimation model for estimating a process processing result for each product used for the fault analysis rule and Q statistics and/or T² statistics, when values of the statistics are the same as set values or more.
